(19) United States
(12) Patent Application Publication
(10) Pub. No.: US 2011/0134596 A1
(43) Pub. Date: Jun. 9, 2011

(54) MOUNTING APPARATUS FOR DATA STORAGE DEVICE

(75) Inventor: XIANG CAO, Shenzhen City (CN)

(73) Assignees: HONG FU JIN PRECISION INDUSTRY (SHENZHEN) CO., LTD., Shenzhen City (CN); HON HAI PRECISION INDUSTRY CO., LTD., Tu-Cheng (TW)

(21) Appl. No.: 12/750,679

(22) Filed: Mar. 30, 2010

(30) Foreign Application Priority Data
Dec. 9, 2009 (CN) 200910311101.X

(51) Int. Cl. G06F 1/16

(52) U.S. Cl. 361/679.31

(57) ABSTRACT

A mounting apparatus for a data storage device includes a bracket, and a fixing member fixed in the bracket. The fixing member includes a securing board, and a plurality of clamping blocks extending from the securing board. The data storage device is fixed to the fixing member. The clamping blocks resist against sidewalls of the data storage device.

### BACKGROUND

1. Technical Field

The disclosure relates to mounting apparatuses for data storage devices, and particularly to a mounting apparatus that readily secures a data storage devices in a computer enclosure.

2. Description of Related Art

Generally speaking, when a computer is assembled, a bracket is mounted in a computer enclosure, to which data storage devices will be attached, often by screws. However, the bracket is just configured to accommodate the data storage devices having right sizes corresponding to the bracket, which limits usage of the bracket, or even the computer.

### BRIEF DESCRIPTION OF THE DRAWINGS

FIG. 1 is an exploded, isometric view of an exemplary embodiment of a mounting apparatus, together with a data storage device.

FIG. 2 is an assembled, isometric view of the mounting apparatus of FIG. 1, with the data storage device mounted to the mounting apparatus.

### DETAILED DESCRIPTION

The disclosure is illustrated by way of example and not by way of limitation in the figures of the accompanying drawings in which like references indicate similar elements. It should be noted that references to “an” or “one” embodiment in this disclosure are not necessarily to the same embodiment, and such references mean at least one.

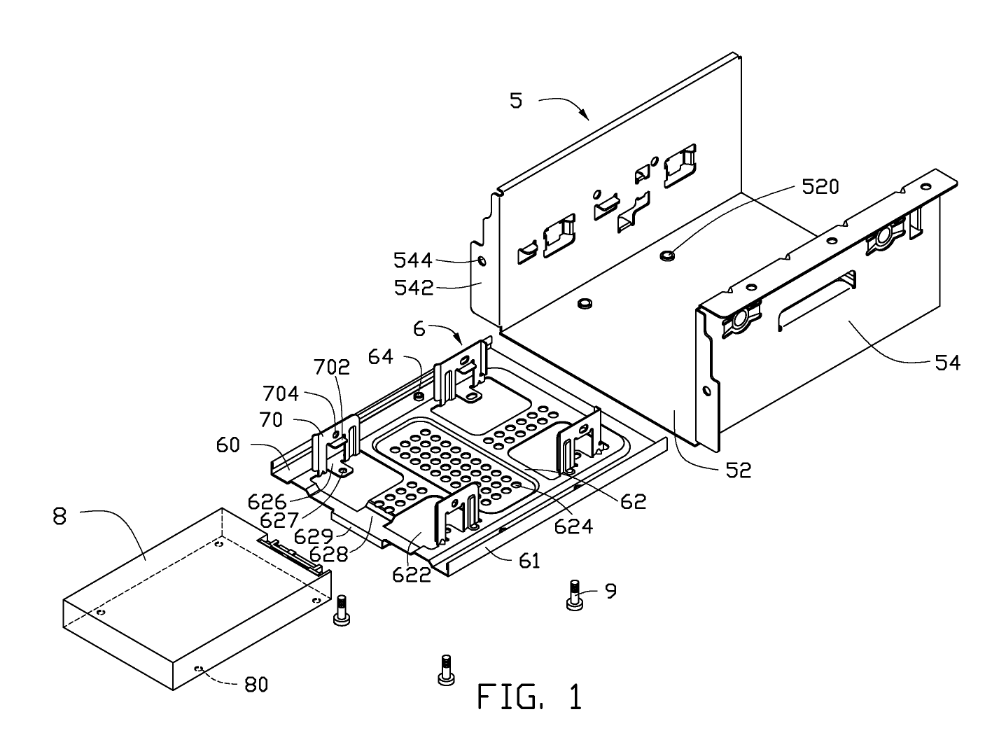

Referring to FIG. 1, an exemplary embodiment of a mounting apparatus is used to mount a first data storage device 8. The mounting apparatus includes a U-shaped bracket 5, a fixing member 6, and a plurality of bolts 9. The bracket 5 is configured to accommodate a second data storage device (not shown) having a greater size than the first data storage device 8, and the second data storage device can be directly fixed to the bracket 5 via screws.

The first data storage device 8 defines a plurality of fixing holes 80 on a bottom of the first data storage device 8, adjacent to opposite longitudinal sides of the data storage device 8.

The bracket 5 includes a bottom plate 52, and two side plates 54 perpendicularly extending from opposite sides of the bottom plate 52. The bottom plate 52 defines a plurality of fastening holes 520, aligned in two lines correspondingly adjacent to the side plates 54. Two fixing tabs 542 extend outside of the bracket 5 from the front ends of the side plates 54, respectively. Each fixing tab 542 defines a screw hole 544, to fix the bracket 5 to a computer (not shown) via screws (not show).

The fixing member 6 includes a securing board 60, and a center of the securing board 60 protruding upwards to form a fixing protrusion 62. Two flanges 61 extend from opposite sides of the securing board 60. The securing board 60 defines a plurality of fixing holes 64, situated between the flanges 61 and the fixing protrusion 62. The fixing protrusion 62 defines four quadrate through holes 622 in four corners of the fixing protrusion 62, and defines a plurality of vents 624 among the through holes 622. A fixing tab 626 extends inwards each through hole 622 from an edge bounding the corresponding though hole 622, neighboring to the corresponding flange 61. Each fixing tab 626 is coplanar with the fixing protrusion 62, and defines a fastening hole 627. Four clamping blocks 70 each perpendicularly extend from the edge of the corresponding through hole 622, and bestride the corresponding fixing tab 626. A distance between the opposite clamping blocks 70 is equal to a width of the first data storage device 8, such that the first data storage device 8 is sandwiched between the opposite clamping blocks 70. A supporting tab 702 extends from an inner side of each clamping block 70. Each supporting tab 702 is parallel to and above the corresponding fixing tab 626, and a distance between each fixing tab 626 and the corresponding supporting tab 702 is larger than a height of the first data storage device 8. Each clamping block 70 defines a fixing hole 704, situated above the corresponding supporting tab 702. The fixing protrusion 62 also defines a groove 628 extending through a front end of the fixing protrusion 62, to conveniently detach the first data storage device 8 from the fixing member 6. An L-shaped hook 629 extends downward from an outer side of the groove 628, and then slants towards a bottom of the fixing protrusion 62.

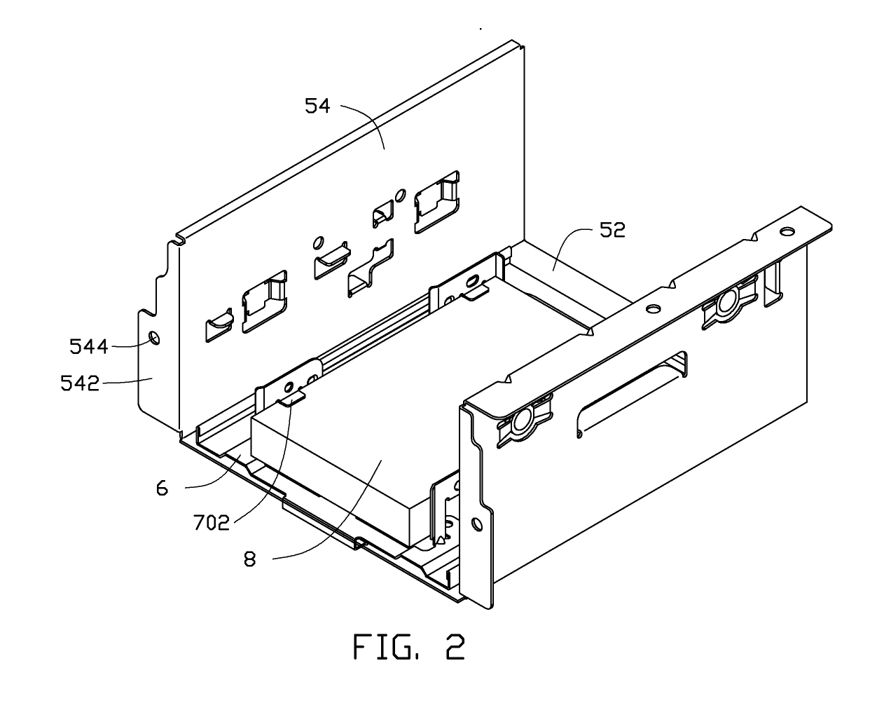

Referring to FIG. 2, in assembly, the first data storage device 8 is placed in the fixing member 6, between the fixing tads 626 and the supporting tabs 702, with the fixing holes 80 of the first data storage device 8 aligned with the fastening holes 627 of the fixing member 6, correspondingly. The bottom of the first data storage device 8 is supported on the fixing tabs 626. The clamping blocks 70 resist against sidewalls of the first storage device 8, respectively. The bolts 9 are extended through the fastening holes 627, and then engaged in the fixing holes 80. Therefore, the first data storage device 8 is fixed to the fixing member 6, with the supporting tabs 702 spaced from a top of the first data storage device 8, for readily dissipating heat generated by the first data storage device 8.

The fixing member 6, together with the first data storage device 8, is placed in the bracket 5, with the hook 629 hooking a front end of the bottom plate 52. A plurality of screws (not shown) are extended through the fastening holes 520 of the bracket 5, and engaged in the fixing holes 64 of the fixing member 6, to fix the fixing member 6 to the bracket 5.

In another embodiment, the supporting tabs 702 can support another data storage device similar to the first data storage device, with screws extending through the fixing holes 704 to engage in sidewalls of said another data storage device.

It is believed that the present embodiments and their advantages will be understood from the foregoing description, and they will be apparent that various changes may be made thereto without departing from the spirit and scope of the description or sacrificing all of its material advantages, the examples hereinbefore described merely being exemplary embodiments.

1. A mounting apparatus for a data storage device, the mounting apparatus comprising:
a bracket comprising a bottom plate; and
a fixing member detachably fixed to the bottom plate of the bracket, the fixing member comprising a securing board parallel to the bottom plate of the bracket, and a plurality of clamping blocks extending from the securing board;
wherein the data storage device is fixed to the fixing member, and the clamping blocks resist against sidewalls of the data storage device, respectively, an L-shaped hook extends from an end of the securing board and hooks the bottom plate of the bracket.

2. (canceled)

3. (canceled)

4. The mounting apparatus of claim 1, wherein the fixing member further comprises a plurality of fixing tabs, each clamping block bestrides a corresponding fixing tab, a supporting tab extends from each clamping block, a bottom of the data storage device is fixed to the fixing tabs, a distance between each fixing tab and the corresponding supporting tab is greater than a height of the data storage device.

5. The mounting apparatus of claim 1, wherein a fixing protrusion protrudes from a center of the securing board, the clamping blocks perpendicularly extend from the fixing protrusion, and a distance between opposite two clamping blocks is almost equal to a width of the data storage device.

6. The mounting apparatus of claim 5, wherein the fixing protrusion defines four quadrate through holes in four corners of the fixing protrusion, a fixing tab extends in each through hole from an edge bounding the corresponding though hole, for fixing the data storage device.

7. The mounting apparatus of claim 6, wherein each fixing tab is coplanar with the fixing protrusion, and defines a fastening hole, four fixing holes are defined in a bottom of the data storage device, four bolts are extended through the fastening holes, and then engaged in the fixing holes.

8. The mounting apparatus of claim 6, wherein the clamping blocks each perpendicularly extend from the edge of the corresponding through hole, and bestride the corresponding fixing tab.

9. The mounting apparatus of claim 8, wherein a supporting tab extends from each clamping block, a distance between each fixing tab and the corresponding supporting tab is greater than a height of the data storage device.
